(19) United States
(12) Patent Application Publication
(10) Pub. No.: US 2026/0193931 A1
(43) Pub. Date: Jul. 9, 2026

(54) DOOR ASSEMBLY ADJUSTMENT DEVICE

(71) Applicant: Gregory James Sullivan, Framingham, MA (US)

(72) Inventor: Gregory James Sullivan, Framingham, MA (US)

(21) Appl. No.: 19/440,799

(22) Filed: Jan. 6, 2026

Related U.S. Application Data
(60) Provisional application No. 63/743,059, filed on Jan. 8, 2025.

(51) Int. Cl. E06B 1/60

(52) U.S. Cl. CPC E06B 1/6076

(57) ABSTRACT

A device for retroactively adjusting a door assembly previously installed within a wall framing includes a bushing that receives a jack screw. The bushing includes a cylindrical sleeve designed to be fixedly mounted into the hinge jamb of the door frame directly behind the lower door hinge. A pair of opposing tabular wings extend outwardly from the sleeve and align behind the hinge jamb. To adjust the door assembly, the jack screw is driven into the sleeve, which ultimately draws the tabular wings into abutment against the rear surface of the hinge jamb. Rotation of the jack screw causes the tabular wings to impart an inward force onto the rear surface of the hinge jamb that can be regulated by adjusting the insertion depth of the jack screw. By precisely adjusting the inward force, the device is effective in straightening an outwardly bowed hinge jamb.

### CROSS-REFERENCE TO RELATED APPLICATIONS

The present invention claims the benefit under 35 U.S.C. 119(e) to U.S. Provisional Patent Application No. 63/743,059, which was filed on Jan. 8, 2025, in the name of Gregory James Sullivan, the disclosure of which is incorporated herein by reference.

### FIELD OF THE INVENTION

The present invention relates generally to the field of carpentry and, more particularly, to devices for adjusting a door assembly installed within a wall framing.

### BACKGROUND OF THE INVENTION

When framing a room, a doorway is typically formed into one of its walls to provide a passageway into the room interior. Referring now to FIG. 1, there is shown a fragmentary, front view of a partially framed wall which is useful in understanding one conventional process for installing a door assembly into a wall framing. As can be seen, wall, or rough, framing 11 comprises spaced apart king studs 13, which are full-length wooden studs that extend vertically between the flooring 15 and the ceiling 17. To create a passageway, a pair of vertical jack, or trimmer, studs 19 are affixed to corresponding king studs 13 and together support a horizontal header, or lintel, 21, which helps to transfer loads from the door assembly to flooring 15. As such, the pair of jack studs 19 and the header 21 together define a rough opening 23 for the doorway.

A door assembly 25 typically comprises a fixed door frame 27 that supports a pivotable door panel 29. Door frame 27 is a multi-sided structure which includes a hinge jamb 31 and a latch jamb 33 which extend vertically in a parallel relationship. A head jamb 35 extends horizontally between the top ends of jambs 31 and 33. Additionally, in certain environments (e.g., for exterior doors), a sill, or threshold, 37 extends horizontally between the bottom ends of jambs 31 and 33.

Door panel 29 is pivotally connected to hinge jamb 31 through upper, middle, and lower hinges 39-1 thru 39-3, respectively. As can be seen, door panel 29 is preferably shaped and dimensioned to substantially enclose the opening defined by door frame 27, with a narrow, uniform door gap 41 preferably maintained therebetween to ensure ease of closure.

To install door assembly 25 in wall framing 11, door frame 27 is first positioned within rough opening 23. For reasons to become apparent below, rough opening 23 is sized such that a narrow, continuous, frame gap, or spacing, 43 is defined between door frame 27 and wall framing 11. A plurality of block-shaped spacers 45 and/or wedge-shaped shims (not shown) are often fixedly secured within frame gap 43 to loosely retain door assembly 25 in place within rough opening 23.

Due to imperfections in the construction of rough opening 23 within wall framing 11, door assembly may not initially hang perfectly in a plumb, level, and square orientation, which in turn may compromise the ability of the door panel 29 to swing properly within door frame 27. Accordingly, shims are typically driven into frame gap 43 at various locations around the periphery of door frame 27 and are selectively driven inward, as needed, to properly orient door assembly 25. With door assembly 25 properly adjusted, screws are driven through the door frame 27 to secure its position. Thereafter, wall board and finish trim are disposed over framing 11 to close the wall in an aesthetic fashion.

Over time, the weight and repeated usage of door panel 29 causes sagging within door frame 27. As seen in FIG. 2, sagging of door panel 29 creates excessive gaping 47 between door panel 29 and latch jamb 33 towards the bottom of door fame 27 and insufficient gaping 49 between door panel 29 and latch jamb 33 towards the top of door frame 27. As can be appreciated, excessive sagging can ultimately prevent door panel 29 from properly closing and latching.

It has been found that door sagging is often caused from warping of hinge jamb 31 behind bottom hinge 39-3. Specifically, in FIG. 3, an enlarged fragmentary view of the partially framed wall 11 in FIG. 1 is shown at its initial stage of door installation. As can be seen, hinge jamb 31 extends straight in a vertical orientation behind bottom hinge 39-3. However, the weight and usage of door assembly 25 imparts a significant load onto hinge jamb 31 through bottom high 39-3. Over time, this load causes hinge jamb 31 to outwardly bow, or warp, behind bottom hinge 39-3, as shown in FIG. 4, even when a solid spacer 45 or shim is positioned behind jamb 31 at the point of the greatest load bearing weight. This outward bowing of the lower portion of hinge jamb 31, in turn, pulls, or pivots, door panel 29 and thereby creates a sagging condition.

A sagging door is most effectively corrected by partially opening the wall (e.g., removing the decorative trim and/or a portion of the wall panel) and wedging material directly behind the lower section of hinge jamb 31 to help absorb the load and thereby minimize, or eliminate, any warping. However, this corrective process has been found to be relatively complex, time-consuming, disruptive, and costly.

Additional approaches are known in the art to reduce the load imparted onto the lower section of a hinge jamb 31 and thereby minimize warping. However, these additional approaches are typically implemented at the initial time of door installation (i.e., as a preventative measure) and are not designed to be readily integrated into a wall after original door installation and wall finishing.

### SUMMARY OF THE INVENTION

In view thereof, it is an object of the present invention to provide a new and improved device for adjusting a door assembly installed within a wall framing.

It is another object of the present invention to provide a device as described above which effectively straightens the section of the hinge jamb of the door assembly that is situated directly behind the bottom door hinge.

It is yet another object of the present invention to provide a device as described above which can be utilized retroactively in a fully installed door assembly without necessitating removal of the door panel or any wall frame trimming.

It is still another object of the present invention to provide a device as described above that has a limited number of parts, is inexpensive to manufacture, and is easy to use.

Accordingly, as one feature of the present invention, there is provided a device for adjusting a door assembly installed within a wall framing, the door assembly having a door frame coupled to the wall framing and a movable door panel that is pivotally connected to a hinge jamb of the door frame through a plurality of door hinges, the plurality of door hinges including a lower door hinge, the device comprising (a) a unitary bushing adapted to be fixedly mounted in the hinge jamb behind the lower door hinge, the unitary bushing comprising a cylindrical sleeve from which extends a pair of tabular wings, and (b) a jack screw adapted to be inserted into the cylindrical sleeve of the unitary bushing in threaded engagement therewith, (c) wherein, through rotation of the jack screw, the wings of bushing are adapted to be drawn into abutment against a rear surface of the hinge jamb, the wings of bushing applying an inward force onto the rear surface of the hinge jamb which can be adjusted through acute rotation of the jack screw.

Various other features and advantages will appear from the description to follow. In the description, reference is made to the accompanying drawings which form a part thereof, and in which is shown by way of illustration, an embodiment for practicing the invention. The embodiment will be described in sufficient detail to enable those skilled in the art to practice the invention, and it is to be understood that other embodiments may be utilized and that structural changes may be made without departing from the scope of the invention. The following detailed description is therefore, not to be taken in a limiting sense, and the scope of the present invention is best defined by the appended claims.

### BRIEF DESCRIPTION OF THE DRAWINGS

In the drawings, wherein like reference numerals represent like parts:

FIG. 1 is a fragmentary, front view of a partially framed, prior art wall which includes a door assembly installed therein, the door panel of the door assembly being shown in its proper condition;

FIG. 2 is a fragmentary, front view of the prior art wall of FIG. 1, the door panel of the door assembly being shown in a sagging condition;

FIG. 3 is an enlarged, fragmentary, front view of the prior art wall of FIG. 1 which is useful in illustrating that proper orientation of the door panel is reliant upon the lower portion of the hinge jamb extending vertically straight;

FIG. 4 is an enlarged, fragmentary, front view of the prior art wall of FIG. 1 which is useful in illustrating that improper orientation, or sagging, of the door panel is often caused from inward bowing of the lower portion of the hinge jamb;

FIG. 5 is a top perspective view of a device for adjusting a door assembly installed within a wall framing, the device being constructed according to the teachings of the present invention;

FIG. 6 is a top perspective view of the bushing shown in FIG. 5;

FIG. 7 is a top perspective view of the screw shown in FIG. 5;

FIG. 8 is an enlarged, left side view of the lower portion of the hinge jamb of a conventional door assembly with the bottom hinge temporarily separated therefrom, the hinge jamb being shown drilled so as to form an oblong slot, the device of FIG. 5 being shown mounted within the oblong slot to illustrate its usefulness in adjusting a door assembly already installed within a wall framing; and

FIG. 9 is an enlarged, fragmentary, front view of the device of FIG. 5 shown mounted in a door assembly which, in turn, has been installed within a wall framing, the device being shown straightening a previously warped hinge jamb of the door assembly.

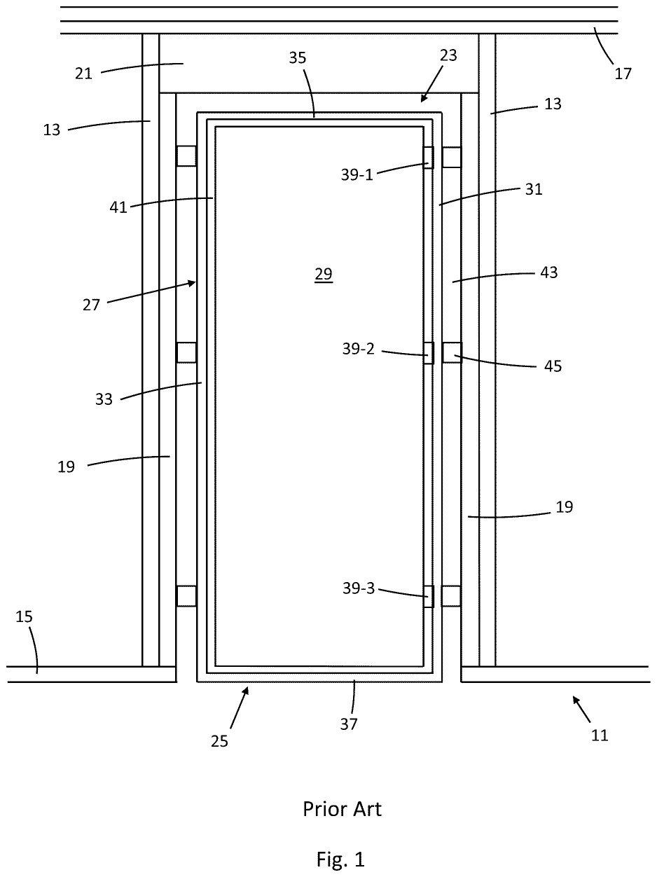

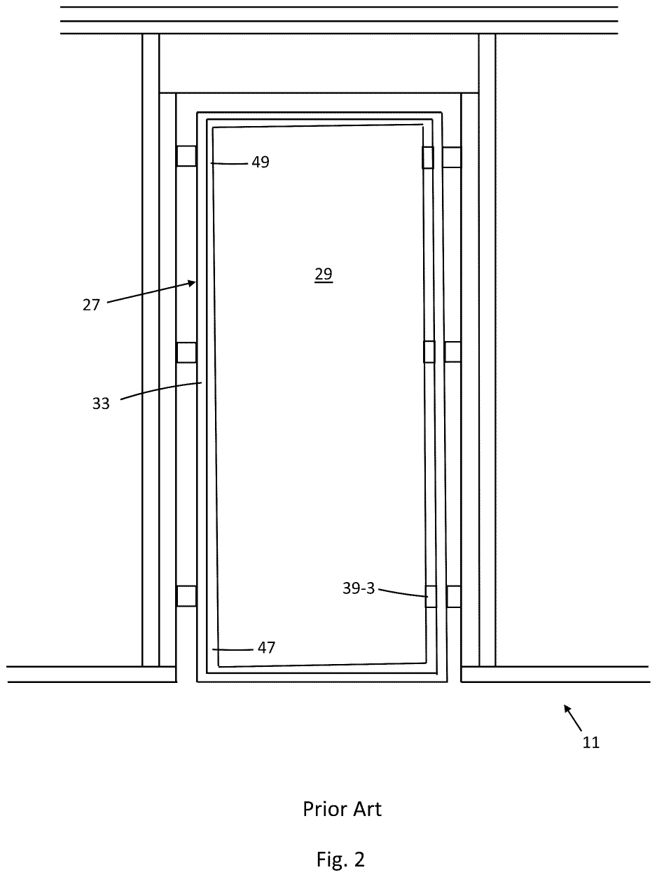

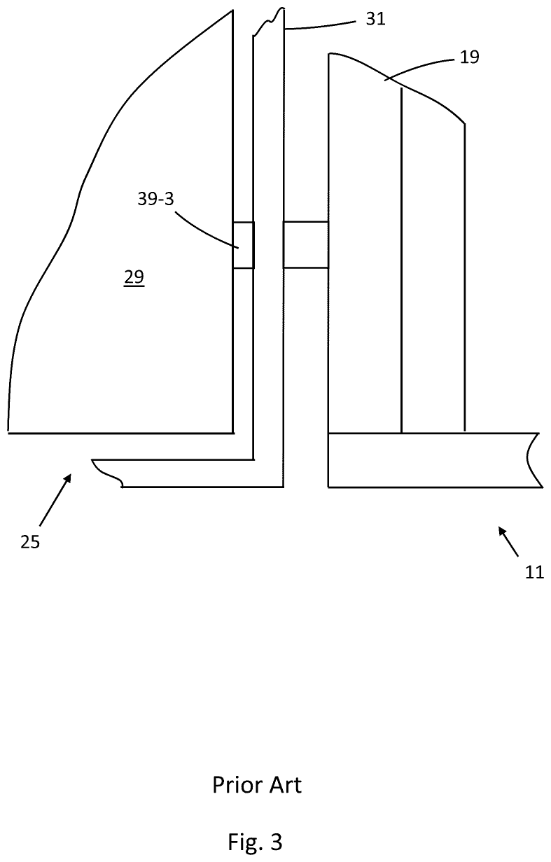

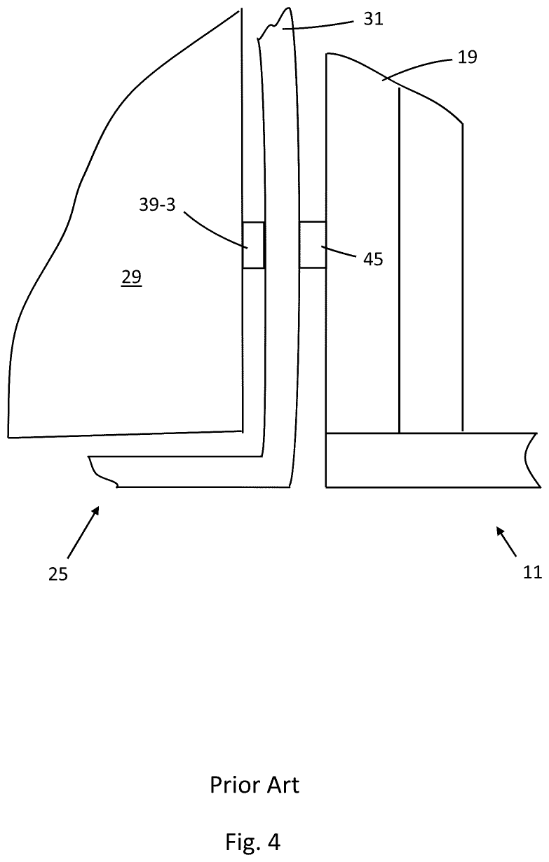

### DETAILED DESCRIPTION OF THE INVENTION

### Door Assembly Adjustment Device 111

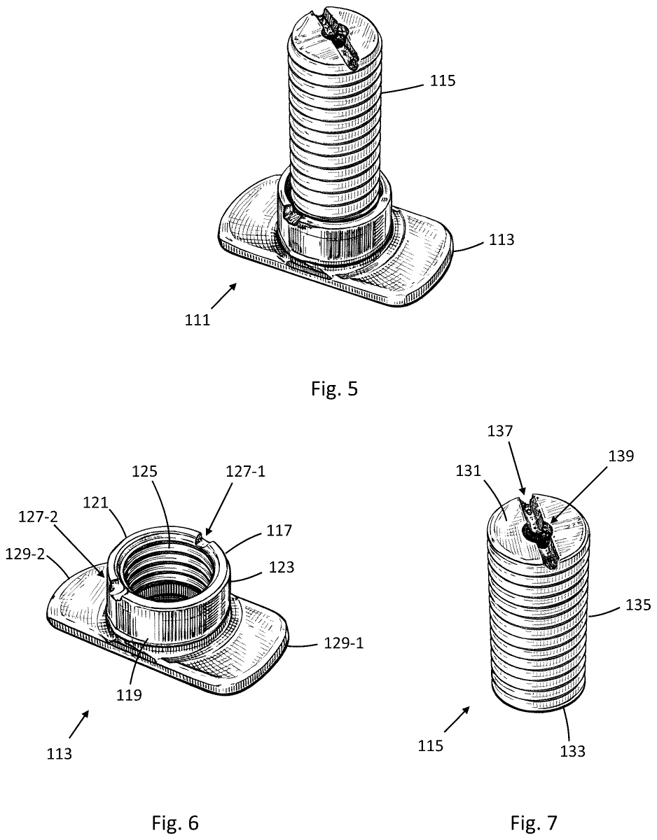

Referring now to FIG. 5, there is shown a top perspective view of a device for adjusting a door assembly installed within a wall framing, the device being constructed according to the teachings of the present invention and identified generally by reference numeral 111. As will be explained in detail below, device 111 corrects for a sagging door by applying a straightening force onto a warped hinge jamb. As a principal feature of the present invention, device 111 is uniquely designed to be utilized retroactively in a fully installed door assembly without necessitating removal of the door panel or any decorative wall frame trimming.

As can be seen, door assembly adjustment device 111 comprises a unitary bushing 113 that receives an elongated screw 115 in threaded engagement therewith. As will be described further in detail below, bushing 113 is configured to be easily installed directly behind a hinge jamb through the recess in which the bottom door hinge is ordinarily retained. Additionally, screw 115 is adapted to be driven through bushing 113 and ultimately in contact with a fixed support surface behind the hinge jamb (e.g., a spacer, shim, or jack stud). Thereafter, rotation of screw 115 causes bushing 113 to travel linearly inward along screw 115. As such, screw 115 effectively acts as a mechanical jack that drives bushing 113 inward so as to apply a straightening force onto the back surface of the hinge jamb. Through precise adjustment of screw 115, a warped hinge jamb can be effectively restored to its original, straight, vertical condition which, in turn, pulls the door panel back to its proper orientation.

As shown in FIG. 6, bushing 113 is constructed as a one-piece metallic member with an overall length of approximately 1.25 inches and an overall height of approximately 0.625 inches. Bushing, or housing, 113 comprises a cylindrical sleeve 117 which is approximately 0.625 inches in outer diameter. Cylindrical sleeve 117 includes a first end 119, a second end 121, an outer surface 123, and an inner surface 125.

As can be seen, inner surface 125 of sleeve 117 is threaded along the entirety of its length and therefore adapted to receive screw 115 in threaded engagement therewith. Additionally, for reasons to become apparent below, a pair of diametrically opposed, U-shaped notches 127-1 and 127-2 is formed into second, or distal, end 121 of sleeve 117.

A pair of tabular wings 129-1 and 129-2 is formed onto and extends outwardly from first end 119 of sleeve 117 in opposing directions, each wing 129 having a rounded rectangular shape and a height, or thickness, of approximately 0.09375 inches. As will be explained further below, bushing 113 is designed to be rotated such that wings 129 abut directly against the back of a hinge jamb. Thereafter, displacement of bushing 113 along screw 115 causes wings 129 to impart an inward linear force that is used to straighten an otherwise bowed hinge jamb.

As shown in FIG. 7, jack screw 115 is in the form of an elongated, cylindrical rod that is constructed of a strong, rigid, and durable material, such as metal. Preferably, screw 115 is approximately 0.5 inches in diameter and in the range from approximately 1 inch to approximately 1.5 inches in length. However, it is to be understood that the dimensions of screw 115 could be modified, as needed, to suit the particular needs of its intended use.

Jack screw 115 includes a first end 131, a second end 133, and an outer surface 135. As can be seen, outer surface 135 is threaded along the entirety of its length and is adapted to engage with inner surface 125 of bushing 113. In this manner, screw 115 is adapted to be rotatably driven through sleeve 117 of bushing 113. To facilitate the driving of screw 115 through bushing 113, a linear diametrical groove 137 is formed in first end 131 and is suitably dimensioned to receive a flat-head screwdriver.

Jack screw 115 is additionally centrally drilled and tapped so as to define an axial threaded bore 139 which extends the entirety of its length. Preferably, threaded bore 139 is dimensioned to receive a standard hinge screw, thereby enabling device 111 to work in concert with standard door hinge hardware.

As referenced briefly above, device 111 is designed as a fastener-type kit that can be utilized retroactively in a fully installed door assembly for corrective purposes. Once permanently installed, device 111 effectively transfers the load of a door imparted through its bottom hinge to the wall framing, as is desired. The step-by-step process for adjusting an installed door assembly using device 111 is set forth in detail below.

### Method of Adjusting an Installed Door Assembly Using Device 111

As referenced above, device 111 is uniquely designed to fix a sagging door in a relatively quick and easy manner. Specifically, as the first step in the correction process, the bottom hinge is unscrewed and pivoted away from the hinge jamb. As such, the door panel remains connected to the hinge jamb through the upper and middle hinges.

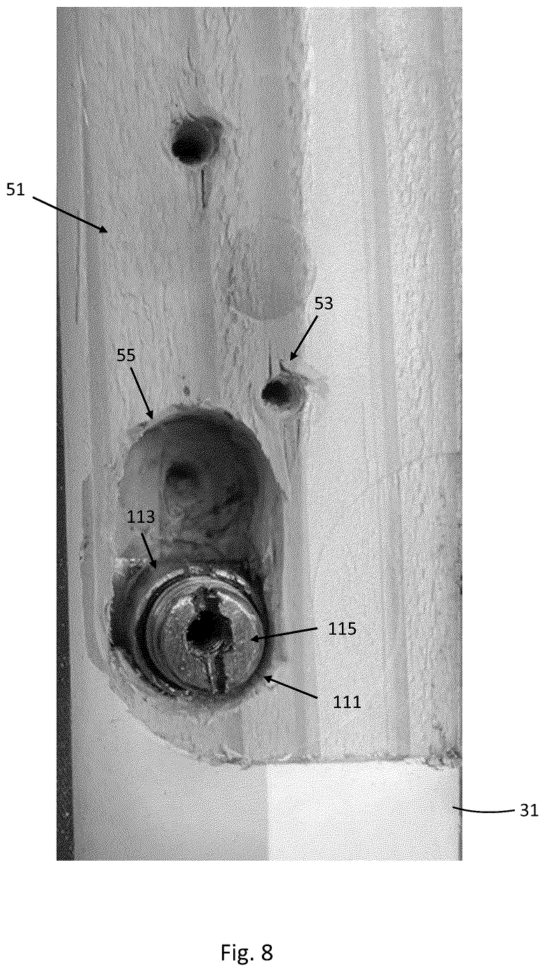

Referring now to FIG. 8, there is shown an enlarged, left side view of the lower portion of the hinge jamb 31 with the bottom hinge temporarily separated therefrom so as to expose the hinge recess 51. As can be seen, screw holes 53 are formed in hinge jamb 31 within hinge recess 51 where the bottom hinge screws were previously retained.

A first hole, approximately ⅝ of an inch in diameter, is drilled into the hinge jamb 31 In direct, central alignment with the lowermost screw hole 53. The first hole is drilled to a depth that extends just beyond the thickness of the hinge jamb 31. In other words, the first hole preferably extends through the entirety of the hinge jamb 31 but prior to reaching any physical structures located directly behind the hinge jamb 31 (e.g., shims, spacers or wall framing).

A second hole of the same diameter and depth is drilled into the hinge jamb 31 directly above the first hole in tangential relationship thereto. Any remaining jamb material situated directly between the two connected holes is removed so as to create an enlarged slot 55 within recess 51 of jamb 31. As can be seen, slot 55 has a rounded rectangular, or oblong, shape.

Thereafter, bushing 113 is oriented with its wings 129 extending vertically and is inserted fully into slot 55 (i.e., centered within slot 55 such that both wings 29 have adequate clearance). A flat-head screwdriver is then inserted into notches 127 in sleeve 117 and rotated clockwise 90 degrees so that both wings 129 are situated directly behind the rear surface of jamb 31, the weight of bushing 113 causing it to drop down to the bottom of slot 55.

Second end 133 of jack screw 115 is inserted into threaded sleeve 117, as shown. A flat-head screwdriver is then inserted into groove 137 and rotated clockwise until second end 133 of screw 115 directly abuts against a fixed surface behind the jamb 31 (e.g., a shim, spacer, or wall framing). Any further rotation of jack screw 115 causes bushing 113 to travel along screw 115 in the forward direction (i.e., towards the exposed surface of the jamb 31).

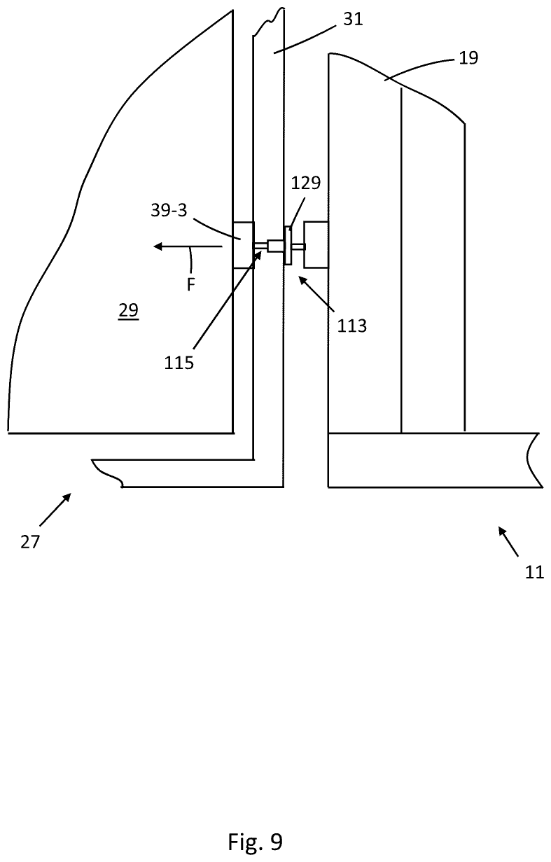

As bushing travels forward, wings 129 are drawn into direct contact against the rear surface of the hinge jamb 31. Accordingly, any further rotation of jack screw 115 causes wings 129 of bushing 113 to apply an inward force F onto the rear surface of the hinge jamb 31, as represented in FIG. 9. Through acute adjustment of jack screw 115, the inward force F applied by bushing 113 can be regulated to ultimately restore the hinge jamb 31 to its original vertical orientation, as shown. With hinge jamb 31 properly adjusted by device 111, door panel 29 hangs and swings properly within door frame 27.

Optionally, a semi-oblong plug (not shown) may be inserted into the open portion of slot 55 for aesthetic purposes and to help retain device 111 in place within the jamb 31. Bottom hinge 39-3 is then pivoted closed into alignment within hinge recess 51. In turn, hinge screws are inserted through bottom hinge 39-3 and back into engagement with hinge jamb 31 through the previously formed screw holes 53. However, the lowermost hinge screw in the bottom hinge 39-3 engages into threaded bore 139 of jack screw 115, since jack screw 115 aligns directly with the previous location of the former lowermost hinge screw hole 53. As a result, with the bottom hinge 39-3 resecured to the hinge jamb 31, the door assembly 25 maintains its original appearance, with device 111 inconspicuous from view.

It should be noted that door assembly adjustment device 111 permanently remains in place within the door assembly 25. Over time, if door panel 29 exhibits any new sagging, bottom hinge 39-3 can be temporarily removed from the hinge jamb 31 and jack screw 115 can be further adjusted to correct the sagging condition.

The invention described in detail above is intended to be merely exemplary and those skilled in the art shall be able to make numerous variations and modifications to it without departing from the spirit of the present invention. All such variations and modifications are intended to be within the scope of the present invention as defined in the appended claims.

What is claimed is:

1. A device for adjusting a door assembly installed within a wall framing, the door assembly having a door frame coupled to the wall framing and a movable door panel that is pivotally connected to a hinge jamb of the door frame through a plurality of door hinges, the plurality of door hinges including a lower door hinge, the device comprising:
(a) a unitary bushing adapted to be fixedly mounted in the hinge jamb behind the lower door hinge, the unitary bushing comprising a cylindrical sleeve from which extends a pair of tabular wings; and
(b) a jack screw adapted to be inserted into the cylindrical sleeve of the unitary bushing in threaded engagement therewith;
(c) wherein, through rotation of the jack screw, the wings of bushing are adapted to be drawn into abutment against a rear surface of the hinge jamb, the wings of bushing applying an inward force onto the rear surface of the hinge jamb which can be adjusted through acute rotation of the jack screw.

2. The device as claimed in claim 1 wherein the inward force applied by the unitary bushing is adapted to straighten the hinge jamb when outwardly bowed.

3. The device as claimed in claim 2 wherein each of the unitary bushing and the jack screw is constructed of a rigid, durable, and strong material.

4. The device as claimed in claim 3 wherein each of the unitary bushing and the jack screw is constructed of metal.

5. The device as claimed in claim 1 wherein the cylindrical sleeve of the bushing comprises a first end, a second end, an outer surface, and an inner surface.

6. The device as claimed in claim 5 wherein the inner surface of the cylindrical sleeve is threaded.

7. The device as claimed in claim 6 wherein the pair of tabular wings is formed onto and extends outwardly from the first end of cylindrical sleeve in opposing directions.

8. The device as claimed in claim 7 wherein the jack screw is in the form of an elongated rod having a first end, a second end, and a threaded outer surface.

9. The device as claimed in claim 8 wherein the threaded outer surface of the jack screw is adapted to engage the inner surface of the cylindrical sleeve when rotatably inserted thereinto.

10. The device as claimed in claim 9 wherein the first end of jack screw is shaped to define a linear diametrical groove which is adapted to receive a flat-head screwdriver.

11. The device as claimed in claim 10 wherein the jack screw is centrally drilled and tapped so as to define an axial threaded bore which is adapted to receive a hinge screw from the lower door hinge.
